(19) United States
(12) Patent Application Publication
(10) Pub. No.: US 2018/0052028 A1
(43) Pub. Date: Feb. 22, 2018

(54) Packaging Unit

(71) Applicant: Colgate-Palmolive Company, New York, NY (US)

(72) Inventors: Michael Paul ROBINSON II, Brooklyn, NY (US); David DEMAR, Tenafly, NJ (US); Roland CHARRIEZ, Peekskill, NY (US)

(73) Assignee: Colgate-Palmolive Company, New York, NY (US)

(21) Appl. No.: 15/561,139

(22) PCT Filed: Mar. 24, 2015
(86) PCT No.: PCT/US2015/022270

§ 371 Date: Sep. 25, 2017

(51) Int. Cl. G01F 19/00; B65D 77/06; B65D 77/24; B65D 75/58; B65D 83/00; B65D 33/00

(52) U.S. Cl. CPC G01F 19/002; B65D 77/06; B65D 77/245; B65D 2203/10; B65D 83/0038; B65D 33/00; B65D 2313/02; B65D 75/58

(57) ABSTRACT

A dispenser including a housing and a scoop. The housing may have a plurality of side walls, a top wall, and a bottom wall. An opening may be formed in at least one of the side walls. The scoop may include a handle and a bowl portion. The bowl portion may be configured to be inserted into an interior volume of the housing through the opening in the housing and to be removed from the interior volume of the housing through the opening in the housing.

### BACKGROUND

Dispensers are used to store products such as pet food, “kitty” litter, and the like. A conventional pet food dispenser may include a housing having an opening on top. A lid may cover the opening to prevent the pet food from spilling out therefrom and to keep the pet food fresh. The lid may be unscrewed by a user, and the user may then pour the pet food into a bowl for the pet to eat. This requires the user to lift the entire dispenser while pouring. The dispenser may be heavy when full, which may make pouring the pet food accurately into the bowl difficult. In addition, the amount of pet food may vary from pour to pour. Therefore, what is needed is an improved dispenser that eases pouring of the product contained therein while enabling more accurate measurement of the amount poured.

### BRIEF SUMMARY

A dispenser is disclosed. The dispenser may include a housing and a scoop. The housing may have a plurality of side walls, a top wall, and a bottom wall. An opening may be formed in at least one of the side walls. The scoop may include a handle and a bowl portion. The bowl portion may be configured to be inserted into an interior volume of the housing through the opening in the housing and to be removed from the interior volume of the housing through the opening in the housing.

In another embodiment, the dispenser may include a housing having a plurality of side walls and a bottom wall. A riser may be positioned within the housing. The riser may be configured to move from a first position to a second position in a direction away from the bottom wall. An external sensor may be coupled to one of the side walls. The external sensor may be configured to detect movement by a user and to transmit a signal to the riser causing the riser to move from the first position to the second position in response to the movement.

A system for distributing packages is also disclosed. The system may include a display case including a shelf, a drawer, or both. A plurality of carriers may be stored on the shelf, in the drawer, or both. Each carrier may include a bag having one or more straps, and each carrier may be expandable and collapsible in at least one direction. A plurality of packages may be stored on the shelf, in the drawer, or both, and the carriers may be sized and shaped to receive one or more of the packages.

A handle is also disclosed. The handle may include first and second portions. The first portion may be configured to receive a user's hand. The second portion may be configured to support one or more packages. The first and second portions may be integral with one another proximate a first end of the handle, and the first and second portions may be configured to be engaged and disengaged from one another proximate a second end of the handle.

Further areas of applicability of the present invention will become apparent from the detailed description provided hereinafter. It should be understood that the detailed description and specific examples, while indicating a preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a perspective view of an illustrative dispenser, according to one or more embodiments disclosed.

FIG. 2 depicts a cross-sectional side view of the dispenser shown in FIG. 1, according to one or more embodiments disclosed.

FIG. 3 depicts a perspective view of the dispenser shown in FIG. 1 with a scoop being removed therefrom, according to one or more embodiments disclosed.

FIG. 4 depicts a perspective view of another illustrative dispenser including a riser in a first position, according to one or more embodiments disclosed.

FIG. 5 depicts a perspective view of the dispenser shown in FIG. 4 with the riser in a second position, according to one or more embodiments disclosed.

FIG. 6 depicts a perspective view of an illustrative bag, according to one or more embodiments disclosed.

FIG. 7 depicts a flowchart illustrating a system for distributing and transporting one or more packages, according to one or more embodiments disclosed.

FIG. 8 depicts an illustrative adjustable carrier, according to one or more embodiments disclosed.

FIG. 9 depicts the adjustable carrier shown in FIG. 8 with two packages positioned therein, according to one or more embodiments disclosed.

FIG. 10 depicts an illustrative handle for carrying one or more packages, according to one or more embodiments disclosed.

FIG. 11 depicts the handle shown in FIG. 10 carrying one package with another package being loaded therein, according to one or more embodiments disclosed.

FIG. 12 depicts a package including an illustrative identification tag, according to one or more embodiments disclosed.

FIG. 13 depicts the package shown in FIG. 12 being placed into a carrier having a corresponding identification tag, according to one or more embodiments disclosed.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

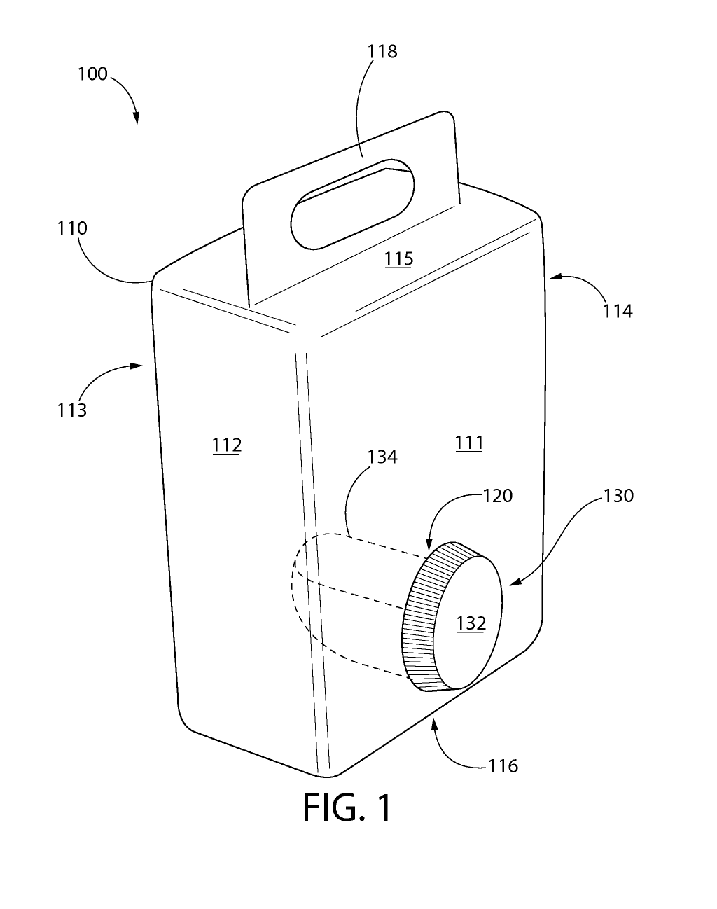

FIG. 1 depicts a perspective view of an illustrative dispenser 100, according to one or more embodiments disclosed. The dispenser 100 may include a housing 110 defining an internal volume. The housing 110 may be a box having a plurality of walls 111-116. For example, the housing 110 may have four side walls 111-114, a top wall 115, and a bottom wall 116. As shown, a handle 118 may be coupled to the top wall 115. In other embodiments, the handle 118 may be coupled to one of the side walls 111-114. The housing 110 may be made of cardboard, plastic, or the like.

The housing 110 may include an opening 120 in one of the side walls (e.g., side wall 111). The opening 120 may be positioned closer to the bottom wall 116 than the top wall 115. The opening 120 may have a cross-sectional shape that is circular, triangular, rectangular, or the like. The opening 120 may be sized and shaped to receive a scoop 130. The scoop 130 may include a handle 132 and a bowl portion 134. The handle 132 may cover the opening 120 when the bowl portion 134 is positioned inside the housing 110 to prevent a product inside the housing 110 from flowing out through the opening 120.

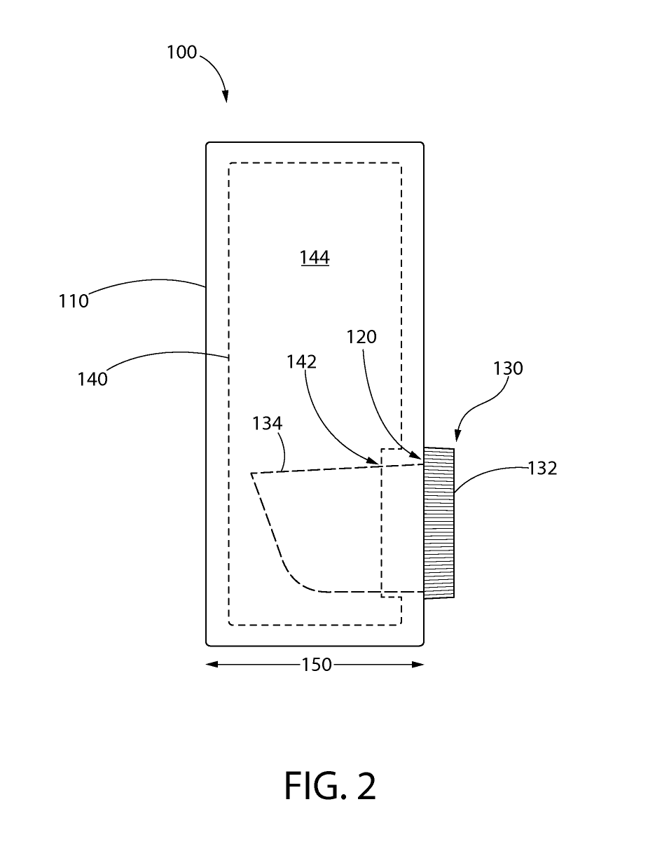

FIG. 2 depicts a side cross-sectional view of the dispenser 100, according to one or more embodiments disclosed. A bag 140 may be disposed within the housing 110. The bag 140 may have a product 144 therein. The product 144 may be or include a granulated, pelletized, or powdered product, or the like, such as food (e.g., cereal, pet food, etc.), cat or “kitty” litter, or the like. In another embodiment, the bag 140 may be omitted, and the product 144 may be placed directly in the housing 110.

The bag 140 may also include an opening 142 that is aligned with the opening 120 in the housing 110 when the bag 140 is positioned within the housing 110. As such, the bowl portion 134 of the scoop 130 may extend through the openings 120, 142 in the housing 110 and the bag 140, respectively, when the handle 132 is in contact (or near-contact) with the side 111 of the housing 110. The bowl portion 134 may extend from about 10% to about 40%, about 40% to about 70%, or about 70% to about 100% of the width 150 of the housing 110 when the handle 132 is in contact with the side 111 of the housing 110. The inner surface of the bowl portion 134 may face upward toward the top surface 115 so that the product 144 may flow into the bowl portion 134 due to gravitational forces.

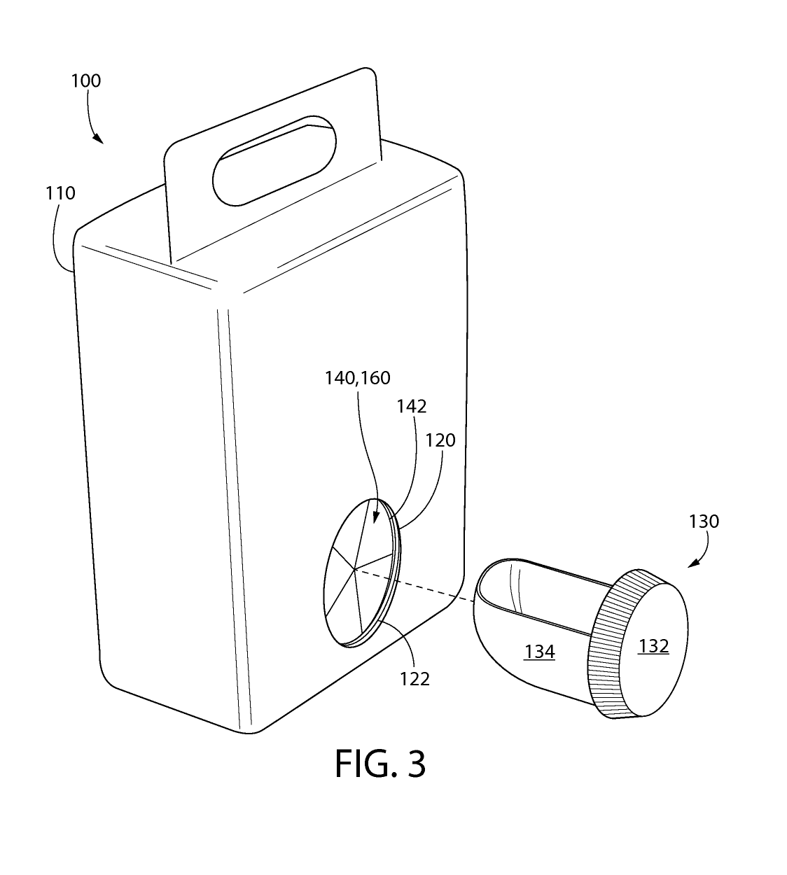

FIG. 3 depicts a perspective view of the dispenser 100 shown in FIG. 1 with the scoop 130 being removed therefrom, according to one or more embodiments disclosed. In operation, when a user wants to remove a portion of the product 144 from the dispenser 100, the user may rotate the handle 132 of the scoop 130. For example, the scoop 130 may be screwed into the housing 110, and the scoop 130 may be rotated one or more revolutions to disengage from the housing 110. This may also help to fill the bowl portion 134 with the product 144. In another embodiment, the rotation of the handle 132 may be omitted as the product 144 may fill the bowl portion 134 due to gravity. The user may then pull the handle 132 away from the housing 102 causing the bowl portion 134 to be withdrawn from the housing 110 and the bag 140 through the openings 120, 142, respectively. The housing 110 and/or the bag 140 may include a valve 160 proximate to the openings 120, 142 that prevents the product 144 from flowing out through the openings 120, 142 when the scoop 130 no longer obstructs the openings 120, 142. The valve 160 may be or include an HDPE flap (e.g., a die-cut HDPE flap).

Once the scoop 130 has been removed, the bowl portion 134 may contain a predetermined amount of the product 144 as a way to manage portion control. The user may pour the product 144 from the scoop 130 into another container (e.g., a food bowl). The user may then insert the bowl portion 134 of the scoop 130 through the openings 120, 142 in the housing 110 and the bag 140.

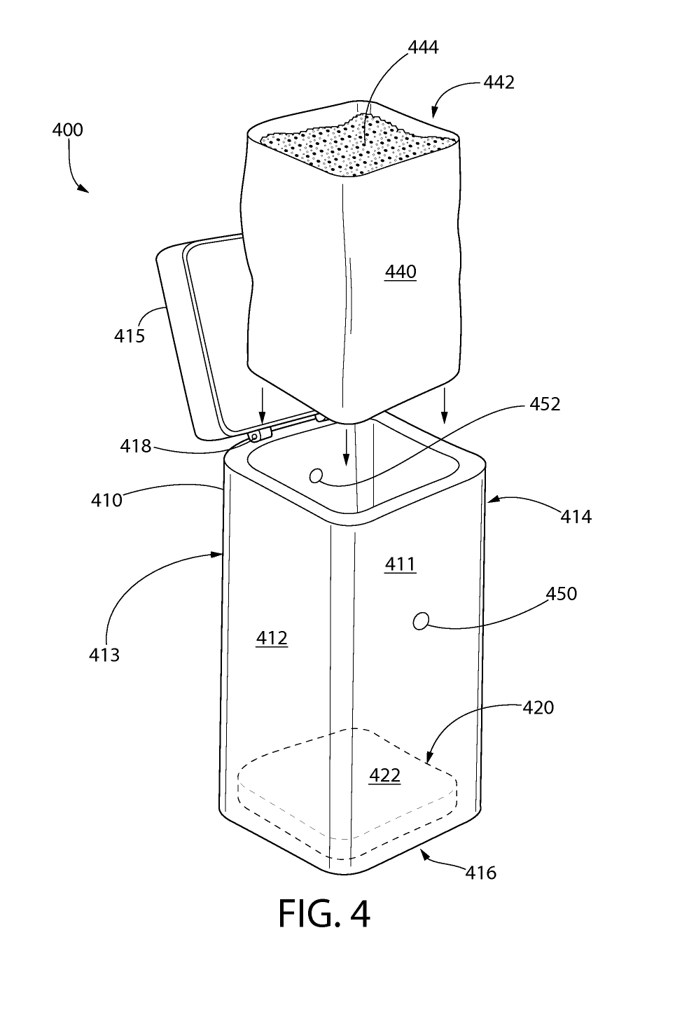

FIG. 4 depicts a perspective view of another illustrative dispenser 400 including a riser 420 in a first position, according to one or more embodiments disclosed. The dispenser 400 may include a housing 410 defining an internal volume. The housing 410 may be a box having a plurality of walls 411-416. For example, the housing 410 may have four side walls 411-414, a top wall 415, and a bottom wall 416. The walls 411, 412 are shown transparent to better illustrate the riser 420. One or more hinges 418 may be used to couple the top wall 415 to one of the side walls (e.g., wall 413). The hinges 418 may allow the top wall 415 to pivot from a closed position to an open position so that it acts as a lid.

A bag 440 may be loaded into the housing 410. The bag 440 may have a product 444 therein. The product 444 may be or include food (e.g., pet food), cat or “kitty” litter, or the like. The bag 440 may have an opening 442 that is aligned with the top wall 415 in the housing 410. In another embodiment, the bag 440 may be omitted, and the product 444 may be placed directly in the housing 410.

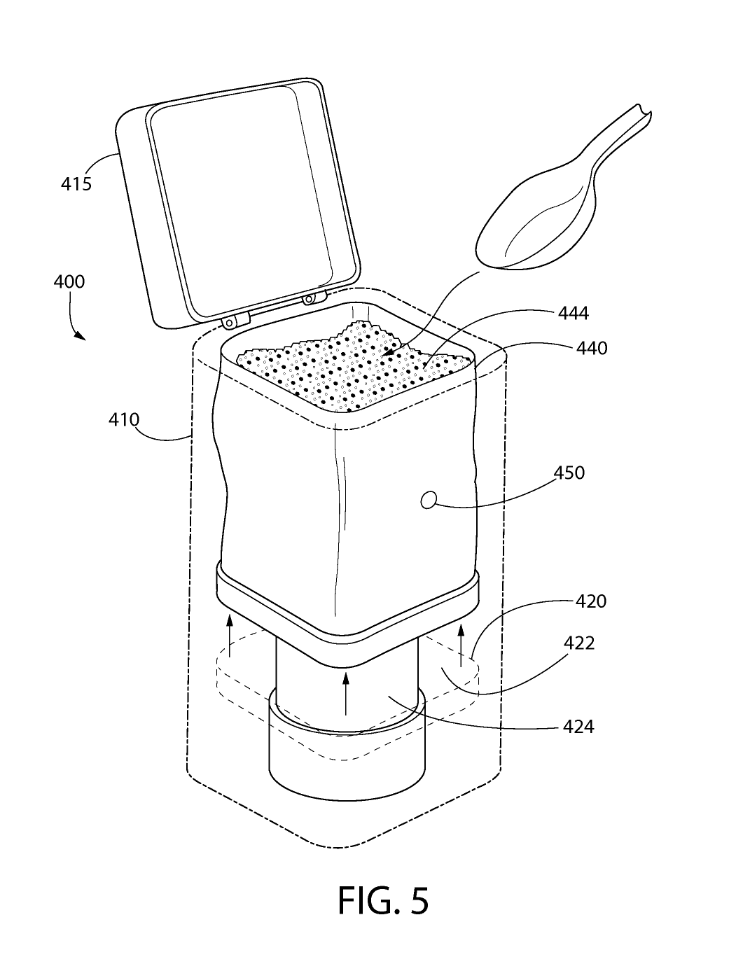

The riser 420 may also be positioned within the housing 410. More particularly, the riser 420 may be positioned between the bottom wall 416 and the bag 440 (when the bag 440 is positioned in the housing 410). The riser 420 may include a platform 422 on which the bag 440 may be placed. The riser 420 is shown in a first or “contracted” position in FIG. 4. The riser 420 may be configured to lift the bag 440 by moving from the first position into a second or “expanded” position (FIG. 5). The riser 420 may be or include a mechanical riser including a motor configured to lift the bag 440. In another embodiment, the riser 420 may be a hydraulic riser including pressurized fluids that may lift the bag 440. In yet another embodiment, the riser 420 may be or include one or more springs configured to lift the bag 440.

An exterior sensor 450 may be coupled to the housing 410. The exterior sensor 450 may be a motion sensor that is configured to sense or detect when the user moves within a predetermined distance in front of the sensor 450. The exterior sensor 450 is discussed in greater detail with respect to FIG. 5. As used herein, the term “user” may refer to a person or an animal (e.g., a pet).

FIG. 5 depicts a perspective view of the dispenser 400 of FIG. 4 showing the riser 420 in the second position, according to one or more embodiments disclosed. In operation, when the user wants to remove the product 444 from the dispenser 400, the user may move in front of the exterior sensor 450. When the exterior sensor 450 detects this movement, the exterior sensor 450 may send a signal to circuitry contained within the riser 420 that causes the riser 420 to actuate from the first position (FIG. 4) to the second position (FIG. 5), thereby lifting the bag 440 within the housing 410. More particularly, a piston 424 may lift the platform 422, thereby lifting the bag 440 within the housing 410. In another embodiment, the user may cause the riser 420 to actuate by pushing a button, turning a crank, pulling a lever, or the like.

The distance between the first position and the second position may depend, at least partially, on a distance between the top of the bag 440 and the top wall 415. For example, an interior sensor 452 (see FIG. 4) may sense or detect when the top of the bag 440 is a predetermined distance (e.g., 1 inch) from the top wall 415, and stop upward movement of the riser 420 when this occurs. The bag 440 may be collapsible such that the height of the bag 440 decreases as the product 444 is removed from the bag 440. As such, in this embodiment, the distance between the first position and the second position of the riser 420 may increase as the amount of product 444 in the bag 440 decreases. In another embodiment, the distance between the first position and the second position (i.e., the distance that the riser 420 lifts the bag 440) may depend, at least partially, on the weight of the bag 440.

The riser 420 may descend back to its original position (as shown in FIG. 4) after the riser 420 lifts each time. For example, the riser 420 may descend back to its original position a predetermined time (e.g., 5 minutes) after the riser 420 lifts, or the riser 420 may descend back to its original position after the top wall 415 closes. In another embodiment, the riser 420 may maintain its position after each lift until the next time the riser 420 lifts to a subsequent position. In this embodiment, the riser 420 may be reset to its original position (as shown in FIG. 4) once the bag 440 is removed and a new bag 440 is inserted into the housing 410.

In at least one embodiment, the upward movement of the bag 440 may cause the top wall 415 to pivot about the hinges 418 and open. In another embodiment, the sensor 450 or 452 may send a separate signal to an actuator (not shown) that causes the top wall 415 to open. In yet another embodiment, the top wall 415 may be opened manually by the user.

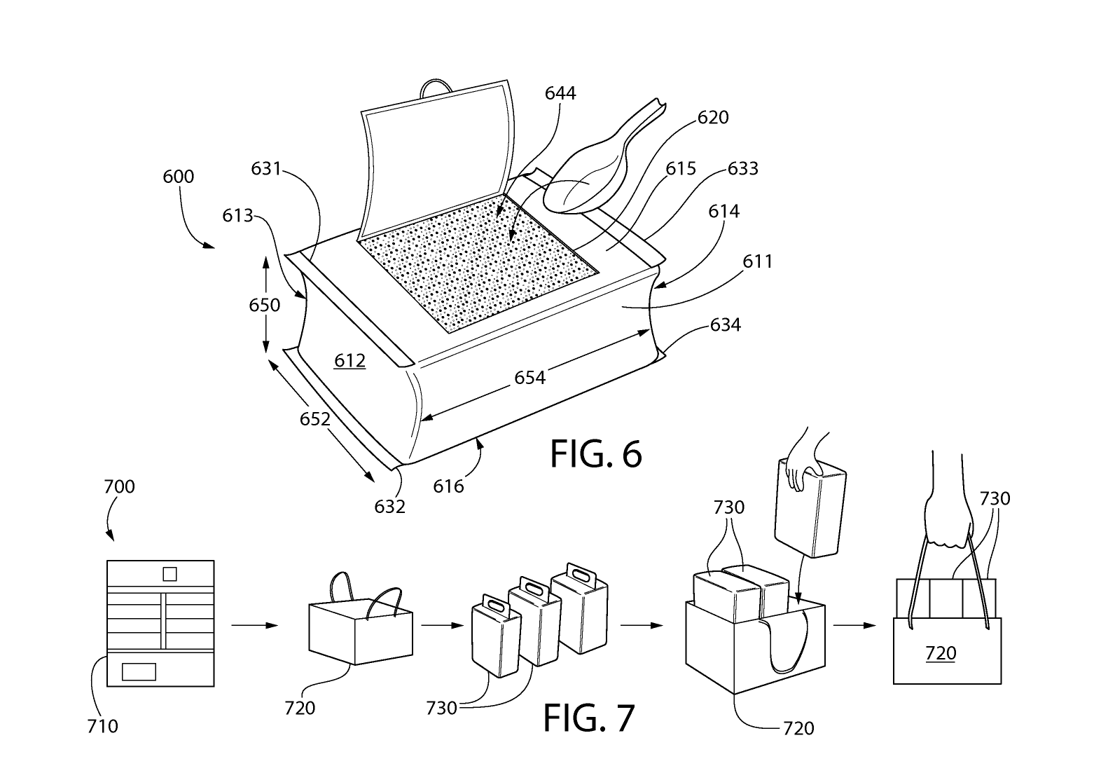

FIG. 6 depicts a perspective view of an illustrative bag 600, according to one or more embodiments disclosed. The bag 600 may be used in the dispenser 100 shown in FIGS. 1-3, the dispenser 400 shown in FIGS. 4 and 5, any other dispenser, or without a dispenser. The bag 600 may include a plurality of walls 611-616. For example, the bag 600 may have four side walls 611-614, a top wall 615, and a bottom wall 616. The bag 600 may include an opening 620 (e.g., in the top wall 615) through which a product 644 may be added or removed. The bag 600 may be made of plastic, laminated paper, molded polymer, molded, paper, polymer film, metal, or the like.

The bag 600 may include one or more struts 631-634 for structural support. The struts 631-634 may be made from metal, wood, plastic, or the like. Although four struts 631-634 are shown, it will be appreciated that more or fewer struts may be used. The struts 631-634 may be positioned along the edges between adjacent walls 611-616. For example, the strut 631 may be positioned along the edge between the side wall 612 and the top wall 615, and the strut 631 may extend (at least partially) axially between the side walls 611, 613. The struts 631-634 may allow the bag 600 to be expandable and collapsible in a first direction 650 (e.g., along the height), while maintaining structural support in a second direction 652 (e.g., along the depth) which may be perpendicular to the first direction 650. In at least one embodiment, one or more additional struts may be added that are perpendicular to struts 631-634 to maintain structural support in a third direction 654 (e.g., along the length) that may be perpendicular to the first and second directions 650, 652.

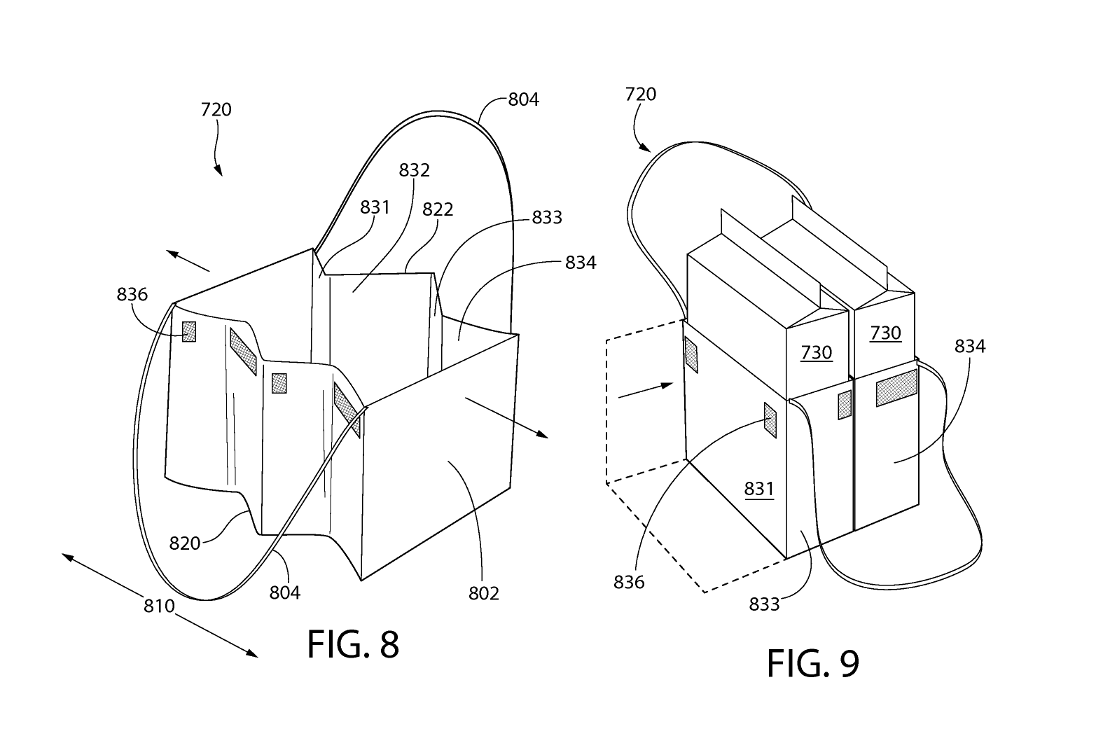

FIG. 7 depicts a flowchart illustrating a system 700 for distributing and transporting one or more packages 730, according to one or more embodiments disclosed. The system 700 may include a display case 710. The display case 710 may be positioned in a retail store (e.g., a grocery store or pet store). The display case 710 may include a plurality of shelves and/or drawers. A plurality of carriers 720 may be positioned on the shelves or in the drawers. The carriers 720 are described in greater detail with respect to FIGS. 8 and 9 below.

A plurality of packages 730 may also be positioned on the shelves or in the drawers. The packages 730 may contain a product, such as a particle-formed product, which may be food (e.g., pet food), cat or “kitty” litter, or the like. The packages 730 may be the same size, weight, or density, or they may be different sizes, weights, or densities. For example, two of the packages 730 may have the same size, but include products of different densities.

The carriers 720 and the packages 730 may be removed from the display case 710 by a customer. The customer may place one or more of the packages 730 into one of the carriers 720. As shown, the carrier 720 may be sized to receive three packages 730; however, in other embodiments, the carrier 720 may be configured to receive more or fewer packages 730.

FIG. 8 depicts the carrier 720 shown in FIG. 7 with no packages 730 therein, and FIG. 9 depicts the carrier 720 shown in FIG. 7 with two packages 730 therein, according to one or more embodiments disclosed. The carrier 720 may include a bag 802 having one or more straps 804. The bag 802 may define an internal volume configured to receive one or more packages 730. The carrier 720 may be expandable and collapsible in at least one direction 810. More particularly, opposing sides 820, 822 of the carrier 720 may include a plurality of panels (four are shown: 831-834). The panels 831-834 may be configured to fold on top of one another when the carrier 720 at least partially collapses (e.g., like an accordion).

The panels 831-834 may be sized and shaped to approximate the size of the packages 730. For example, each panel 831-834 may have a width that is substantially equal to a width of one package 730. In another embodiment, each panel 831-834 may have a width that is substantially equal to a width of two, three, four, etc. packages 730 positioned next to one another. In yet another embodiment, each package 730 may have a width that is substantially equal to two, three, four, etc. panels 831-834.

The panels 831-834 may include attachment devices 836. As shown, each panel 831-834 includes one attachment device 836 on the outer surface thereof. However, in other embodiments, each panel 831-834 may include more than one attachment device 836, and/or the attachment devices 836 may be positioned on the inner surface of the panels 831-834. The attachment devices 836 may be or include a fabric hook and loop fastener, such as VELCRO® strips, adhesive material, hooks, or the like. The attachment devices 836 may be used to couple or secure two adjacent panels (e.g., panels 831, 832) together when the carrier 720 is carrying less than the maximum number of packages 730, as shown in FIG. 9.

FIG. 10 depicts an illustrative handle 1000 for carrying one or more packages, according to one or more embodiments disclosed. The handle 1000 may include a first or “upper” portion 1010 and a second or “lower” portion 1020. The first portion 1010 may be configured to receive a user's hand. As shown, the first portion 1010 may include one or more recesses 1012 on the inner surface thereof that are sized and shaped to have the user's fingers fit therein to enhance gripping.

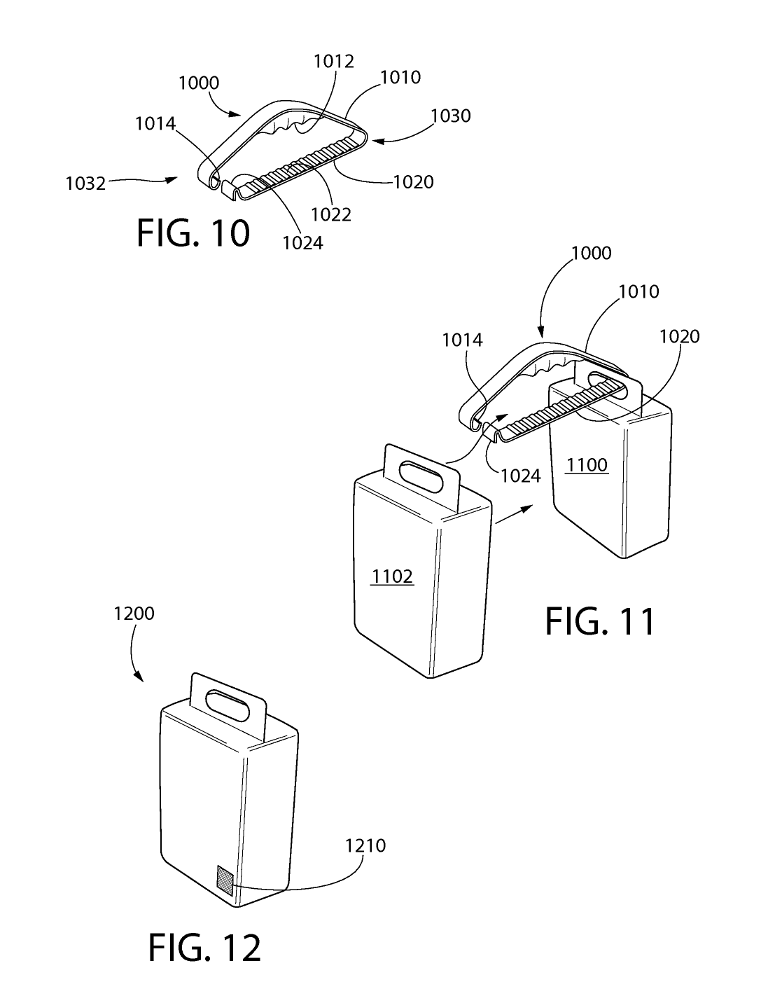

The second portion 1020 may be configured to receive and support one or more packages (shown in FIG. 11). The second portion may include one or more recesses 1022 on the inner surface thereof. The recesses 1022 may be configured to secure the one or more packages in place while the user carries them (i.e., to prevent the packages from sliding back and forth along the second portion 1020).

The first and second portions 1010, 1020 may be integral with one another proximate to a first end 1030 of the handle 1000. The first and second portions 1010, 1020 may be configured to couple and decouple from one another proximate to a second, opposing end 1032 of the handle 1000. As shown, the first portion 1010 may include an upward-facing hook 1014, and the second portion 1020 may include a corresponding downward-facing hook 1024. The hooks 1014, 1024 may be configured to engage one another to couple the first and second portions 1010, 1020 together. Although shown with the hooks 1014, 1024, in other embodiments, the second end 1032 of the handle 1000 may include other structures for coupling and decoupling such as a snap, a buckle, a string that may be tied, or the like.

FIG. 11 depicts the handle 1000 shown in FIG. 10 carrying one package 1100 with another package 1102 being loaded therein, according to one or more embodiments disclosed. The packages 1100, 1102 may be loaded into the handle 1000 when the first and second portions 1010, 1020 are decoupled proximate to the second end 1032, as shown in FIG. 11. Each package 1100, 1102 may be positioned in a recess 1022 in the second portion 1020 to prevent the packages 1100, 1102 from sliding along the second portion 1020 and/or to balance the weight of the packages 1100, 1102 on the second portion 1020. Once the packages 1100, 1102 are loaded into the handle 1000, the hooks 1014, 1024 may engage one another to couple the first and second portions 1010, 1020 together (e.g., for transport). The packages 1100, 1102 may be removed from the handle 1000 by disengaging the hooks 1014, 1024 to decouple the first and second portions 1010, 1020.

FIG. 12 depicts a package 1200 including an illustrative identification tag 1210, according to one or more embodiments disclosed. The tag 1210 may be a radio frequency identification (“RFID”) tag. In other embodiments, the tag 1210 may be another printed electronics circuit for remote sensing, remote communicating, or the like. For example, the tag 1210 may be a near field communication (“NFC”) tag including an antenna, a radio chip, and a data memory. The NFC tag may draw power (via magnetic induction) from a device that can read it (e.g., a cellphone or scanner). In another embodiment, the tag may include a battery. Once energized, the NFC tag may enable short-range wireless transfer of its data to the device. The antenna range may be, for example, up to about 2 inches, up to about 6 inches, up to about 12 inches, or more.

The tag 1210 may include information about the package 1200. For example, the tag 1210 may include the type of product contained therein, the size of the package 1200, the weight or density of the package 1200, the location of the package 1200 (e.g., through GPS), or a combination thereof.

In at least one embodiment, the tag 1210 may be scanned or otherwise read in the store (e.g., a grocery store or pet store). For example, the tag 1210 may be scanned when the package 1200 arrives at the store or is placed onto a shelf in the store. The scanned information may be stored in a database. The tag 1210 may be scanned again when the package 1200 is purchased. This may also be stored in the database to update the database on the status of the package 1200 and/or the inventory of packages 1200 in the store as a whole.

This information may be used to, for example, alert a clerk in the store when the inventory in the store (e.g., on the shelves) is getting low. This information may also be accessed by a customer to determine the location of the package 1200 in the store (e.g., the particular aisle and/or shelf). In another embodiment, a customer may input the product information (e.g., type of food, brand, diet information) into the customer's cellphone, and the cellphone may notify the customer when the customer walks within a predetermined distance from the tag 1210 of the desired package 1200.

In addition, this information may be accessed by a customer to determine whether a particular store has the package 1200 that the customer seeks to buy. For example, the information in the database may be accessible by the customer via a website or through an application or “app” on the customer's phone. The website or application may also provide recommendations for which products to buy based upon input information from the customer such as, in the case of pet food, the type of pet, size of the pet, dietary restrictions for the pet, etc.

In another embodiment, the tag 1210 may be used provide an electronic device belonging to the customer with notifications. The electronic device may be or include a computer, a mobile phone, a tablet, or the like. The tag 1210 may be active and transmit a signal containing the notification, or the tag 1210 may be passive such that customer's electronic device may obtain the notification information from the tag 1210. The notification may inform the customer how many packages 1200 that the customer has remaining (e.g., “only one package left, buy more”). In another embodiment, when the product in the package 1200 is pet food, the notification may inform the customer when to feed the pet and/or how much of the food has been given to the pet over a given amount of time (e.g., one week).

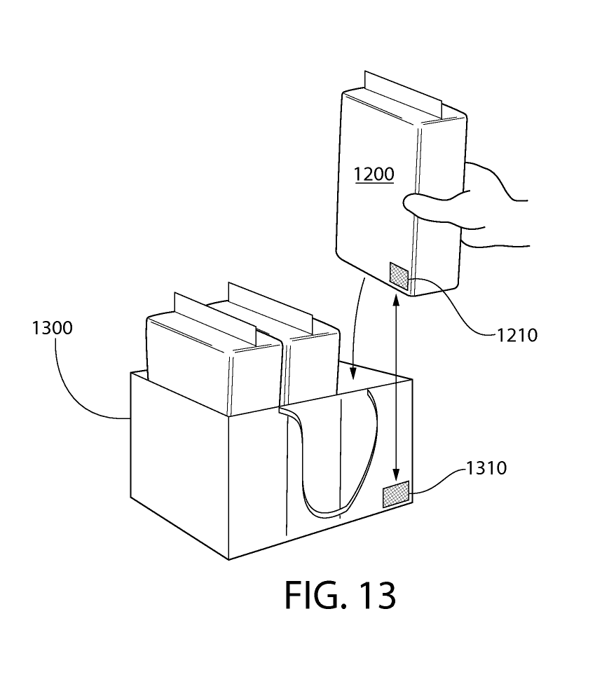

FIG. 13 depicts the package 1200 shown in FIG. 12 being placed into a carrier 1300 having a corresponding identification tag 1310, according to one or more embodiments disclosed. At least one of the tags (e.g., tag 1310) may have a power source (e.g., a battery) that allows the tag 1310 to transmit a signal to the corresponding tag (e.g., tag 1210). In at least one embodiment, the tag 1310 may continuously be in the “on” state. In another embodiment, the tag 1310 may be actuated between the “on” and “off” states with a button or switch to save energy.

In operation, when the package 1200 is placed within a predetermined distance from the tag 1310 on the carrier 1300, the tag 1310 on the carrier 1300 may send a signal (e.g., a magnetic induction signal) to the tag 1210 on the package 1200 and receive a corresponding signal from the tag 1210 on the package. The predetermined distance may be when the package 1200 is placed inside the carrier 1300. The signal received by the tag 1310 on the carrier 1300 may include information about the package 1200 placed in the carrier 1300. For example, the information may include when the package 1200 was put into and taken out of the carrier 1300, the contents of the package 1200, and the like. The tag 1310 on the carrier 1300 may accumulate such information so that it may be determined how many packages 1200 have been positioned within the carrier 1300 within a predetermined amount of time (e.g., 1 week).

1-12. (canceled)

13. A system for distributing packages, comprising:
a display case comprising a shelf, a drawer, or both;
a plurality of carriers stored on the shelf, in the drawer, or both, wherein each carrier comprises a bag having one or more straps, and wherein each carrier is expandable and collapsible in at least one direction; and
a plurality of packages stored on the shelf, in the drawer, or both, wherein the carriers are sized and shaped to receive one or more of the packages.

14. The system of claim 13, wherein each carrier includes a pair of opposing side walls, and wherein each side wall includes a plurality of panels that are configured to fold upon one another when the carrier collapses.

15. The system of claim 14, further comprising:
a first attachment device coupled to a first one of the panels; and
a second attachment device coupled to a second one of the panels, wherein the first and second attachment devices are configured to engage one another when the carrier collapses to secure the carrier in a collapsed position.

16. The system of claim 15, wherein the first attachment device is positioned on an exterior of the first panel.

17. The system of claim 13, further comprising a first identification tag coupled to a first one of the packages, wherein the first identification tag has information stored thereon including a type of product contained in the first package, a size of the first package, a weight or density of the first package, a location of the first package, or a combination thereof.

18. The system of claim 17, wherein the first identification tag comprises a radio frequency identification tag.

19. The system of claim 17, further comprising a second identification tag coupled to a first one of the carriers, wherein at least one of the first and second identification tags includes a power source allowing the second identification tag to receive at least a portion of the information from the first identification tag when the first and second identification tags are within a predetermined distance from one another.

20. The system of claim 19, wherein the first and second identification tags are within the predetermined distance when the first package is placed within the first carrier.

21-24. (canceled)
